(19) United States
(12) Patent Application Publication
(10) Pub. No.: US 2021/0167531 A1
(43) Pub. Date: Jun. 3, 2021

(54) MULTIBOARD POWER CONNECTOR

(71) Applicant: SIGNIFY HOLDING B.V., EINDHOVEN (NL)

(72) Inventors: Dustin KING, EINDHOVEN (NL); Carlton Bruce PLUNK, EINDHOVEN (NL)

(21) Appl. No.: 17/045,611

(22) PCT Filed: Apr. 4, 2019
(86) PCT No.: PCT/EP2019/058529

§ 371 Date: Oct. 6, 2020

Related U.S. Application Data
(60) Provisional application No. 62/654,866, filed on Apr. 9, 2018.

(30) Foreign Application Priority Data
Jun. 11, 2018 (EP) 18176921.7

(51) Int. Cl. H01R 12/70; H01R 12/73; H01R 12/72; H01R 12/58

(52) U.S. Cl. CPC H01R 12/7082; H01R 12/73; H01R 12/58; H01R 12/721; H01R 12/7005

(57) ABSTRACT

Multiboard power connector (1) including a housing with a plurality of insertion points to receive multiple circuit boards. The circuit boards, received into the insertion points (12), come into electrical contact with two rails, the rails carrying opposing charges. The rails comprise a first rail and second rail. The first rail defines a longitudinal axis and a first plurality of terminals, while the second rail is divided into at least two portions that are disposed on opposite sides of the first rail, with a second plurality of terminals extending from the two portions. The first plurality of terminals and second plurality of terminals alternate on each side, such that a plurality of terminals, one from each rail, is disposed adjacent to each insertion point. A circuit board, being received at the insertion point, thus contacts one terminal from each rail and thus receives power. This multiboard power connector, as described here and throughout this disclosure, is cheap to make and allows quick attachment of multiple circuit boards to a driver without a multitude of wires.

### FIELD OF INVENTION

The present disclosure is directed generally to a multiboard power connector.

### BACKGROUND

The use of LEDs has been common in general lighting application for several years. During this time, problems have arisen due to the way the LEDs are configured in the luminaire. Currently in the market, LED arrays are assembled to PCBs (circuit boards) that have wire connections for solid wire or harness connections. A majority of constructions for luminaires use multiple boards that wire to a single driver, because this is the most effective way to produce LED boards for this application. These constructions all have one thing in common: All LED boards require both a positive and negative connection that connects to the LED driver wire to provide power. This means that for a multiple-board construction, there are at least four wires needed to provide power to all the boards. Extrapolating outward, a two-by-four luminaire with four boards requires eight wires to be wired between the driver and the boards. For luminaires with more than four boards, this issue is even more pronounced.

Boards are wired with eighteen gauge solid wires plugged into the connectors provided on the board. These wires are often routed under the boards to prevent the them from crossing an LED and creating a shadow. This is a labor-intensive and time-consuming process. In addition, wires underneath the circuit boards can cause thermal issues, leading to overheating and reduced life expectancy of the LEDs and the luminaire.

### SUMMARY OF THE INVENTION

Accordingly, there exists a need in the art for a simple, cheap-to-fabricate, electrical connector that can power multiple circuit boards without running one or more wires to each.

The present disclosure relates to a multiboard power connector. The multiboard power connector comprises a housing with a plurality of insertion points to receive multiple circuit boards. The circuit boards, received into the insertion points, come into electrical contact with two rails, the rails carrying opposing charges. The rails comprise a first rail and second rail. The first rail defines a longitudinal axis and a first plurality of terminals, while the second rail is divided into at least two portions that are disposed on opposite sides of the first rail, with a second plurality of terminals extending from the two portions. The first plurality of terminals and second plurality of terminals alternate on each side, such that a plurality of terminals, one from each rail, is disposed adjacent to each insertion point. A circuit board, being received at the insertion point, thus contacts one terminal from each rail and thus receives power. This multiboard power connector, as described here and throughout this disclosure, is cheap to make and allows quick attachment of multiple circuit boards to a driver without a multitude of wires.

Various embodiments and implementations herein are directed to a multiboard power connector, comprising: a first rail comprising a first body and defining a longitudinal axis, the first rail including a first plurality of terminals, a first set of the first plurality of terminals extending outward from a first side of the first body in a first direction and a second set of the first plurality of terminals extending outward from a second side of the first body in a second direction, the first direction and second direction being opposed, wherein the first rail is conductive; a second rail comprising a second body and including a second plurality of terminals, wherein a first set of the second plurality of terminals extend outwardly from a first portion of the second body in the first direction, the first portion being disposed adjacent to the first side of the first body, wherein a second set of the second plurality of terminals extend outwardly from a second portion of the second body in the second direction, the second portion being disposed adjacent to the second side of the first body, the second rail further comprising a crossover portion connecting the first portion and the second portion and crossing the longitudinal axis; wherein the first set of the first plurality of terminals and the first set of the second plurality of terminals alternate along a first axis, the first axis being substantially parallel to the longitudinal axis; wherein the second set of the first plurality of terminals and the second set of the second plurality of terminals alternate along a second axis, the second axis being substantially parallel to the longitudinal axis.

According to an embodiment, the first portion comprises a first segment and a second segment, the first and second segments being separated by a first gap, wherein at least one terminal of the first set of the first plurality of terminals extends through the first gap.

According to an embodiment, the second portion comprises a third segment and a fourth segment being separated by a second gap, wherein at least one terminal of the second set of the first plurality of terminals extends through the second gap.

According to an embodiment, a first crossover portion connects the first segment and the third segment, the first crossover portion crossing the longitudinal axis, wherein a second crossover portion connects the second segment and the fourth segment, the second crossover portion crossing the longitudinal axis.

According to an embodiment, the first rail comprises a fifth segment and a sixth segment, wherein the fifth segment is disposed in a first channel defined by the first segment, the first crossover portion, and the third segment, wherein the sixth segment is disposed in a second channel defined by the second segment, the second crossover portion, and the fourth segment.

According to an embodiment, the multiboard connector further comprises a housing defining an interior space, the first rail and the second rail being disposed within the interior space, wherein the housing defines a plurality of insertion points, each insertion point of the plurality of insertion points being dimensioned to receive a corresponding circuit board having a set of contacts comprising a first contact and a second contact.

According to an embodiment, the plurality of insertion points comprises a first set of insertion points, each insertion point of the first set of insertion points being positioned such that the first contact of the corresponding circuit board, received into one of the insertion points of the first set of insertion points, engages with one terminal of the first set of the first plurality of terminals and the second contact of the corresponding circuit board engages with one terminal of the first set of the second plurality of terminals.

According to an embodiment, the plurality of insertion points comprises a second set of insertion points, each insertion point of the second set of insertion points being positioned such that the first contact of the corresponding circuit board, received into one of the insertion points of the second set of insertion points, engages with one terminal of the second set of the first plurality of terminals and the second contact of the corresponding circuit board engages with one terminal of the second set of the second plurality of terminals.

According to an embodiment, the housing defines a cover and a base, the cover being connected to the base by a post. The fifth segment and the sixth segment are connected together by a first intermediate portion, the intermediate portion deviating from the longitudinal axis, wherein the second segment and the third segment are connected together by a second intermediate portion, wherein the first intermediate portion and the second intermediate portion together are in an encircling relation with the post.

According to an embodiment, the housing is gabled about a vertex, the vertex being perpendicular to the longitudinal axis.

According to an embodiment, the first rail is gabled about a first vertex and the second rail is gabled about a second vertex, the first vertex and the second vertex each being perpendicular to the longitudinal axis.

According to another aspect, a first rail comprising a first body and defining a longitudinal axis, the first rail including a first plurality of terminals, a first set of the first plurality of terminals extending outward from a first side of the first body in a first direction and a second set of the first plurality of terminals extending outward from a second side of the first body in a second direction, the first direction and second direction being opposed, wherein the first rail is conductive; a second rail comprising a second body and including a second plurality of terminals, wherein a first set of the second plurality of terminals extend outwardly from a first portion of the second body in the first direction, the first portion being disposed adjacent to the first side of the first body, wherein a second set of the second plurality of terminals extend outwardly from a second portion of the second body in the second direction, the second portion being disposed adjacent to the second side of the first body, the second rail further comprising a crossover portion connecting the first portion and the second portion and crossing the longitudinal axis; and a housing defining an interior space, the first rail and the second rail being disposed within the interior space, wherein the housing defines a plurality of insertion points, each insertion point of the plurality of insertion points being dimensioned to receive a corresponding circuit board having a set of contacts comprising a first contact and a second contact, wherein the first set of the first plurality of terminals and the first set of the second plurality of terminals alternate along a first axis, the first axis being substantially parallel to the longitudinal axis, wherein the second set of the first plurality of terminals and the second set of the second plurality of terminals alternate along a second axis, the second axis being substantially parallel to the longitudinal axis, wherein the first portion comprises a first segment and a second segment, the first and second segments being separated by a first gap, wherein at least one terminal of the first set of the first plurality of terminals extends through the first gap, wherein the second portion comprises a third segment and a fourth segment being separated by a second gap, wherein at least one terminal of the second set of the first plurality of terminals extends through the second gap.

According to an embodiment, a first crossover portion connects the first segment and the third segment, the first crossover portion crossing the longitudinal axis, wherein a second crossover portion connects the second segment and the fourth segment, the second crossover portion crossing the longitudinal axis, wherein the first rail comprises a fifth segment and a sixth segment, wherein the fifth segment is disposed in a first channel defined by the first segment, the first crossover portion, and the third segment, wherein the sixth segment is disposed in a second channel defined by the second segment, the second crossover portion, and the fourth segment.

According to an embodiment, the plurality of insertion points comprises a first set of insertion points, each insertion point of the first set of insertion points being positioned such that the first contact of the corresponding circuit board, received into one of the insertion points of the first set of insertion points, engages with one terminal of the first set of the first plurality of terminals and the second contact of the corresponding circuit board engages with one terminal of the first set of the second plurality of terminals.

According to an embodiment, the plurality of insertion points comprises a second set of insertion points, each insertion point of the second set of insertion points being positioned such that the first contact of the corresponding circuit board, received into one of the insertion points of the second set of insertion points, engages with one terminal of the second set of the first plurality of terminals and the second contact of the corresponding circuit board engages with one terminal of the second set of the second plurality of terminals.

It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein. It should also be appreciated that terminology explicitly employed herein that also may appear in any disclosure incorporated by reference should be accorded a meaning most consistent with the particular concepts disclosed herein.

These and other aspects of the invention will be apparent from and elucidated with reference to the embodiment(s) described hereinafter.

### BRIEF DESCRIPTION OF THE DRAWINGS

In the drawings, like reference characters generally refer to the same parts throughout the different views. Also, the drawings are not necessarily to scale, emphasis instead generally being placed upon illustrating the principles of the invention.

FIG. 1A depicts a perspective view of a multiboard power connector, in accordance with an embodiment.

FIG. 1B depicts a perspective view of a multiboard power connector, in accordance with an embodiment.

FIG. 2A depicts a perspective view of a multiboard power connector in electrical engagement with a plurality of circuit boards, in accordance with an embodiment.

FIG. 2B depicts a perspective, partial-cutaway view of a multiboard power connector in electrical engagement with a plurality of circuit boards, in accordance with an embodiment.

FIG. 3 depicts an exploded view of a multiboard power connector, in accordance with an embodiment.

FIG. 4 depicts an end of a circuit board, in accordance with an embodiment.

FIG. 5 depicts a bottom view of conductive rails, in accordance with an embodiment.

FIG. 6A depicts a perspective view of a first rail, in accordance with an embodiment.

FIG. 6B depicts a top view of a first rail, in accordance with an embodiment.

FIG. 7A depicts a perspective view of a second rail, in accordance with an embodiment.

FIG. 7B depicts a bottom view of a second rail, in accordance with an embodiment.

FIG. 8 depicts a side view of a multiboard power connector, in accordance with an embodiment.

FIG. 9 depicts a side view of a terminal, in accordance with an embodiment.

### DETAILED DESCRIPTION

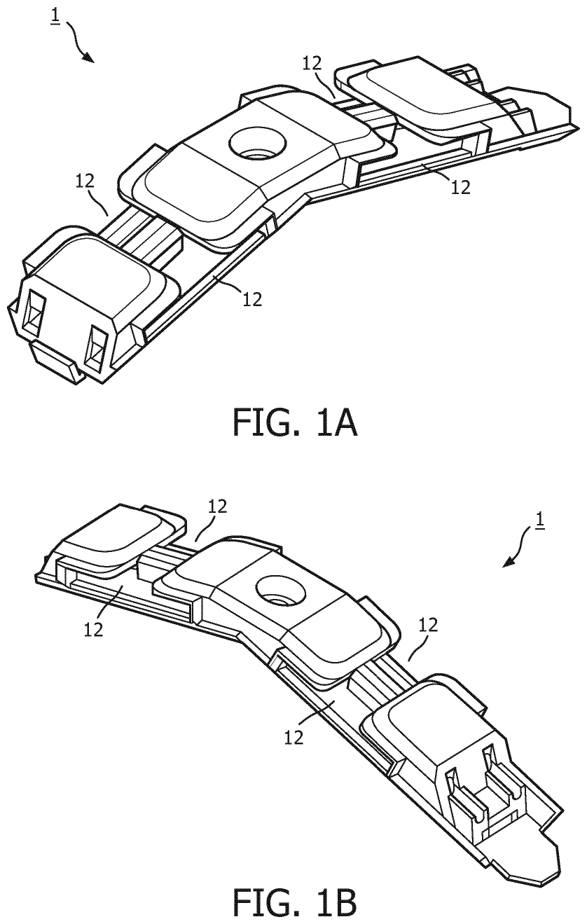

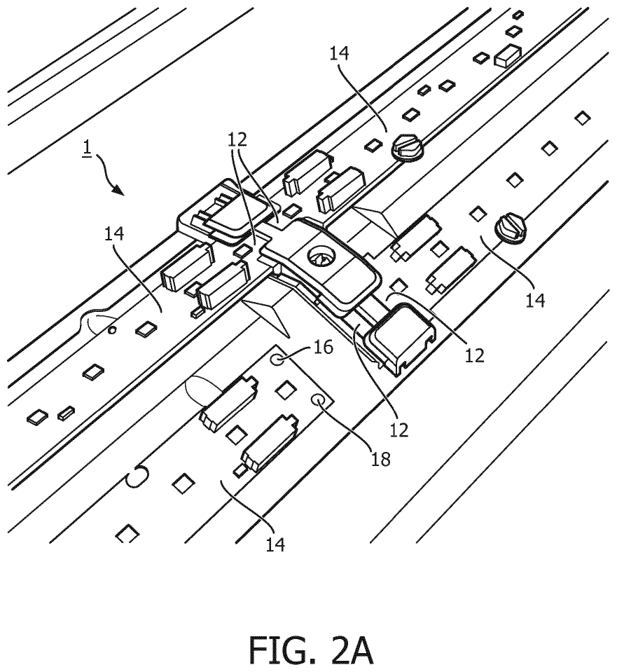

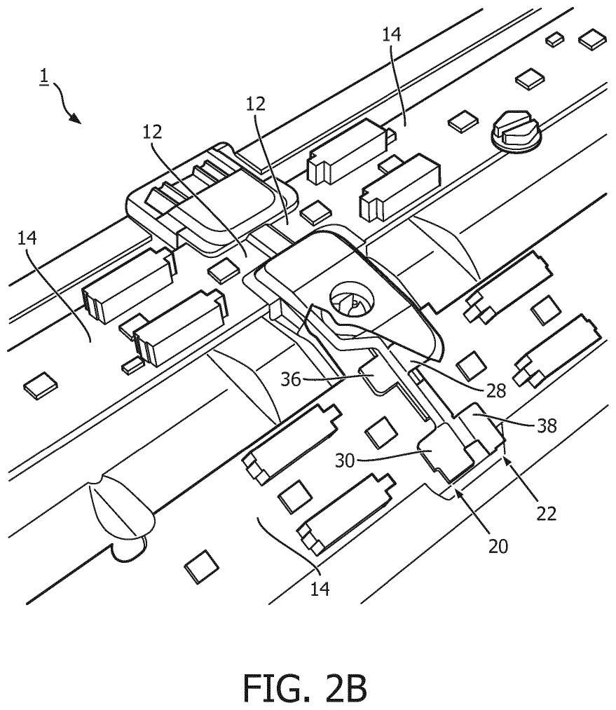

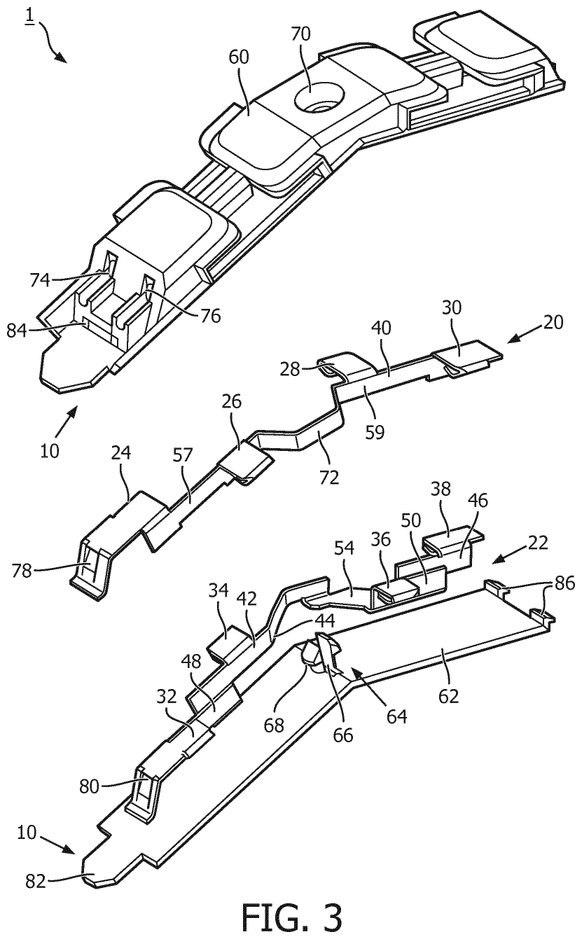

Referring to FIGS. 1A and 1B there is shown alternate perspective views of a multiboard power connector 1. The multiboard power connector 1 comprises a housing 10 that defines an interior space and a plurality of insertion points 12. As shown in FIGS. 2A and 2B, each insertion point 12 is dimensioned to receive a corresponding circuit board 14 including two contacts 16, 18 (see, e.g., FIGS. 2-3). Two rails, a first rail 20 and a second rail 22, may be disposed within the housing 10. (First rail 20 and second rail 22 may be seen, for example, in housing 10 in the exploded view of FIG. 3.).

The first rail 20 and second rail 22 are complementary but electrically insulated from each othereach rail 20, 22 being configured to carry a charge opposite from the other rail, the charge being received from a driver. For example, the first rail 20 may be configured to carry a positive charge and the second rail 22 may be configured to carry a negative charge (although it should be understood that these charges may be reversed). Each rail 20, 22 includes a plurality of terminals with, as shown in the cutaway view of FIG. 2B, a pair of terminals—one terminal from each of the first rail 20 and the second rail 22—being respectively positioned adjacent to a corresponding insertion point 12 in order to engage with the respective contacts of the circuit board 14 received at the insertion point 12. Each insertion point 12 is thus adjacent to a respective pair of terminals, one from each rail 20, 22.

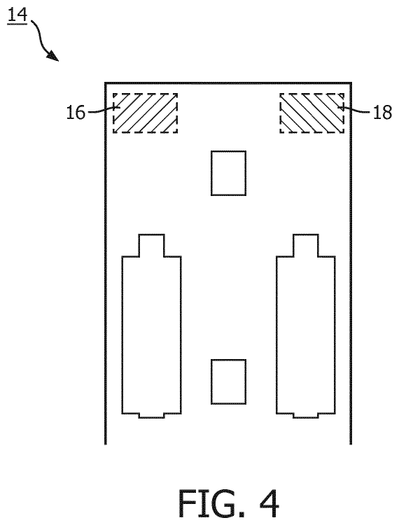

FIG. 4 depicts an example circuit 14 as might be received in one of insertion points 12. In general, the circuit boards 14 that are received into the insertion points are each configured to have similarly-positioned contacts 16, 18. For example, the first contact 16 on each circuit board may be a positive contact (designed to receive a positive charge), whereas the second contact 18 on each circuit board may be a negative contact (designed to receive a negative charge). Although each circuit board 14 may include different kinds of electronics that may be powered via current received through contacts 16, 18, in an embodiment, at least one string of LEDs, disposed on each circuit board 14, will be powered. Contacts 16, 18 may be rectangular (as opposed to the standard circular contacts) in order to increase the surface area (and thus ensure contact with a corresponding terminal) and to match the footprint of the terminals depicted in the various figures.

Using circuit boards 14 with similarly-positioned contacts 16, 18 allows the circuit boards to be modularly substituted for a different circuit board 14, either to replace a failed circuit board 14 or upgrade or change the type of circuit board.

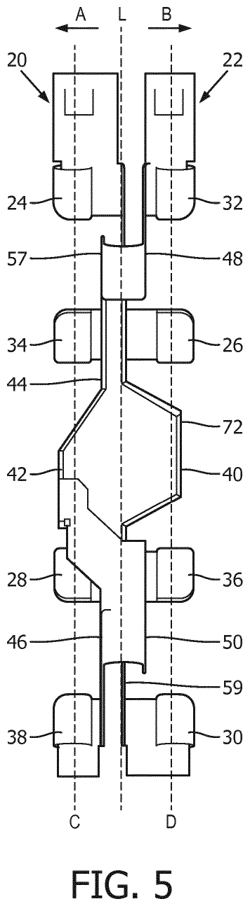

In order for two rails to respectively power four different circuit boards 14 having similarly-positioned contacts 16, 18, the first rail 20 and second rail 22 must be complementary (meaning that they fit together) but insulated from one another (to prevent a short). To that end, the first rail 20 and second rail 22 may be structured to fit together as shown in the exploded view afforded in FIG. 3 and the bottom view of FIG. 5. At a high level, each rail 20, 22 includes four terminals—the first rail 20 includes terminals 24, 26, 28, and 30, while the second rail 22 includes terminals 32, 34, 36, and 38. Because the contacts 16, 18 of circuit boards 14 are similarly placed with respect to one another, and because each rail 20, 22 is configured to carry one charge, the corresponding terminal (one of terminals 24, 26, 28, and 30) from the first rail 20 must be consistently on one side of each insertion point in order to engage with the second contact 18, while the terminal (one of terminals 32, 34, 36, and 38) from the second rail 22 must be consistently on the other side of the insertion point to engage with the first contact 16. As shown in FIG. 5, and as will be described in detail below, the terminals on each side of the multiboard power connector 1 alternate between terminals from the first rail 20 and terminals from the second rail 22, such that a pair of terminals from each rail 20, 22, may be adjacent to each insertion point 12.

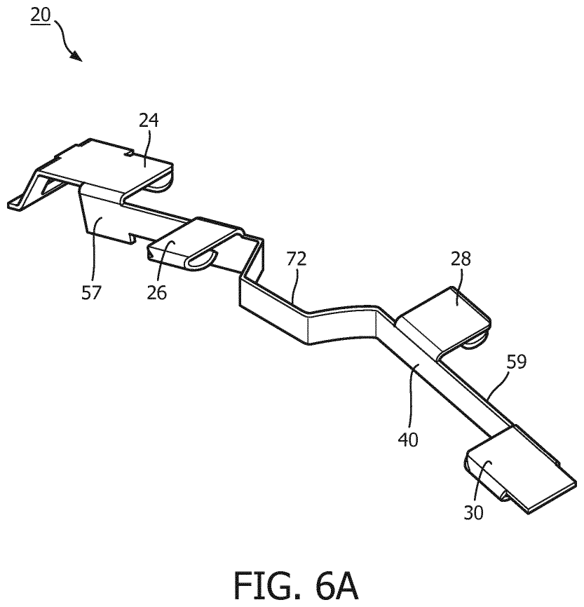

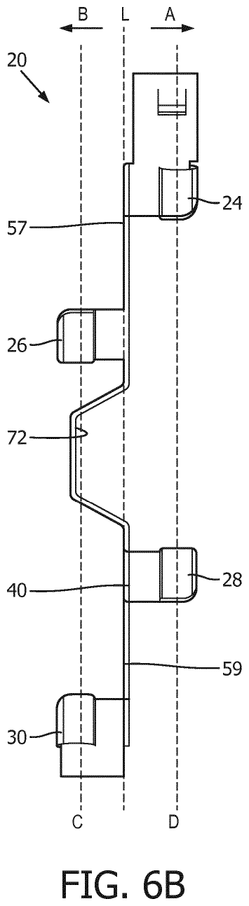

Describing the rails 20, 22 individually, first rail 20 as shown in FIGS. 6A and 6B, comprises a first body 40 defining a longitudinal axis L. As described above, first rail 20 includes a first plurality of terminals 24, 26, 28, and 30. The first plurality of terminals 24, 26, 28, 30 may be divided into a first set 24, 28 and a second set 26, 30. The first set 24, 28 extends outwardly (i.e., away from) a first side (in FIG. 6B, the right-hand side) of the first body 40 in a first direction A. The second set 26, 30 extends outwardly from a second side (in FIG. 6B, the left-hand side) of the first body 40 in a second direction B. As shown, the first direction A and second direction B are generally opposing.

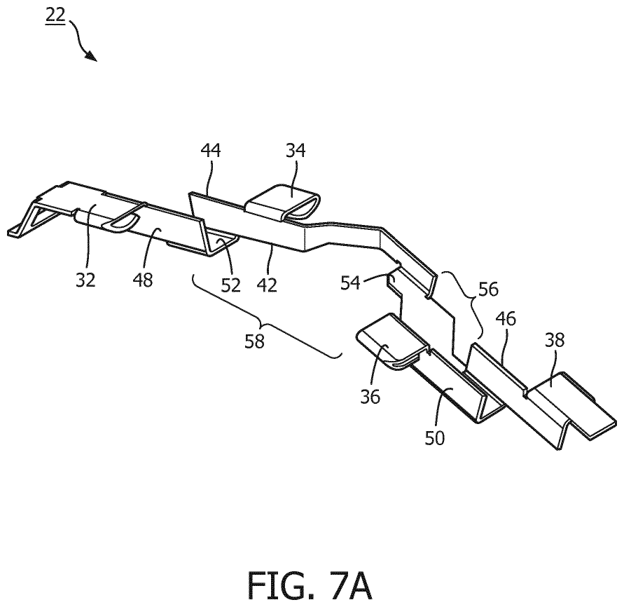

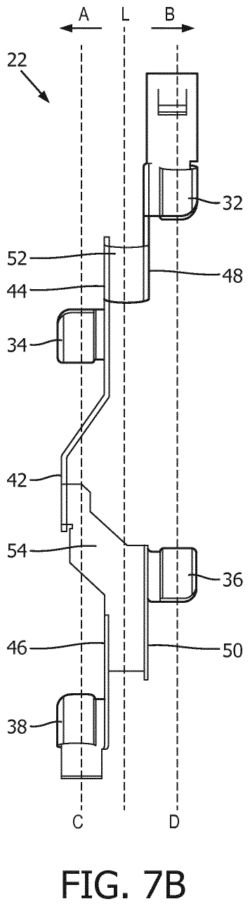

Turning to FIGS. 7A and 7B, the second rail 22 comprises a second body 42 that is divided into: first segment 44, second segment 46, third segment 48, and fourth segment 50, and first crossover portion 52 and second crossover portion 54. The segments may be organized into a first portion 44, 46 and a second portion 48, 50. When the first rail 20 and the second rail 22 are fit together, the segments organized into a first portion 44, 46 will be disposed adjacent to the first side of the first body 40, and the segments organized into the second portion 48, 50 will be disposed adjacent to the second side of the first body 40. As described above, the second rail 22 includes a second plurality of terminals 32, 34, 36, 38 which may be divided into a first set 34, 38 that extend outwardly from the first portion 44, 46 in the first direction A, and a second set 32, 36 that extend outwardly from the second portion 48, 50 in the second direction B.

The various portions 44, 46 and 48, 50 of the second rail 22 are connected together by at least one crossover portion, shown in FIG. 7A as crossover portions 52 and 54. Each crossover portion 52, 54 crosses the longitudinal axis L such that the first portion 44, 46 and the second portion 48, 50 may be disposed on different sides of the first rail 20.

In order for one terminal from each of the first rail 20 and second rail 22 to be disposed adjacent to a corresponding insertion point 12, the terminals from each rail 20, 22 must alternate along each side of the multiboard connector 1. Thus, as shown in FIG. 5, when the first rail 20 and second rail 22 are fit together, the first set of terminals 24, 28 of the first rail 20 and the first set of terminals 34, 38 of the second rail alternate along a first axis C substantially parallel to the longitudinal axis L, disposed adjacent to the first side of the first rail 20 and first portion 44, 46 of the second rail 22. Similarly, the second set 26, 30 of the first plurality of terminals and the second set 32, 36 of the second plurality of terminals alternate along a second axis D substantially parallel to the longitudinal axis L, disposed adjacent to the second side of the first rail 20 and the second portion 48, 50 of the second rail 22.

In this disclosure, “substantially parallel,” as the phrase relates to axes C and D, describes the relative positioning of the terminals on one side of the multiboard connector 1, being disposed lengthwise along the multiboard connector 1 to engage with the contacts 16,18 of the circuit boards 14. It should thus be understood that axes C and D need not be perfectly parallel with the longitudinal axis L.

In order for the terminals to alternate along the first axis C and second axis D, the first portion 44, 46 and the second portion 48, 50 must each define a gap, shown, for example, in FIG. 7A, for at least one terminal of the first plurality of terminals 24, 26, 28, 30 to extend through. For example, the first segment 44 and second segment 46 may define a first gap 56, through which at least one terminal 28 of the first plurality of terminals may extend. Similarly, the third segment 48 and fourth segment 50 together define a second gap 58 and through which at least one terminal 26 of the first plurality of terminals may extend.

In the sum, the total terminals (in the embodiment shown) extending in the first direction thus comprise terminals 24, 28, 34, 38, which, beginning on the one side (the left-hand side in FIG. 5) are arranged, from the top (with respect to FIG. 5), in the following alternating order along the first axis: terminal 24, terminal 34, terminal 28, and terminal 38. Terminal 24 extends past the side of the first segment 44 that does not define the first gap 56; terminal 34 extends from the first segment 44; terminal 28 extends through the first gap 56; and terminal 38 extends from the second segment 46.

Similarly, the terminals extending in the second direction comprise terminals 26, 30, 32, and 36, which beginning on the right-hand side of FIG. 5, from the top, are arranged in the following alternating order along the second axis D: terminal 32, terminal 26, terminal 36, and terminal 30. Terminal 32 extends from the third segment 48; terminal 25 extends through the second gap 58; terminal 36 extends from the fourth segment 50; and terminal 30 extends past the side of the fourth segment 50 that does not define the second gap 58.

Seen another way, the terminals of each of the first rail 20 and second rail 22 alternate between the first direction A and the second direction B along their respective bodies 40, 42. Beginning, for example, on the left-hand side of the first rail 20, as shown in FIG. 6A, and moving towards the right, the terminal 24 extends in the first direction A, terminal 26 extends in the second direction B, terminal 28 extends in the first direction A, and terminal 30 extends in the second direction B. The second rail, by contrast, forms the mirror image of the first rail 20, and thus, beginning on the left-hand side of FIG. 7A: terminal 32 extends in the second direction B, terminal 34 extends in the first direction A, terminal 36 extends in the second direction B, and finally terminal 38 extends in the first direction A. This results, when first rail 20 and second rail 22 are fit together as shown in FIG. 5, in a terminal from each rail 20, 22 being disposed across from a terminal of the opposite rail, thus defining four pairs of terminals two pairs on each side (first pair 24, 34 and second pair 28, 38 on the first side extending in direction A, and third pair 32, 26 and fourth pair 36, 30 on the second side extending in direction B), each pair being positioned to engage the contacts of a circuit board 14, and each pair respectively corresponding to one insertion point 12 of the housing 10.

Each segment 44, 46, 48, 50 of the second rail 22 thus includes at least one corresponding terminal (respectively, terminal 34, terminal 38, terminal 32, and terminal 36). And thus the major portions of segments 44, 46, 48, 50, of the second rail 22 are arranged in the same staggered order as the terminals of the second rail 22 as described above.

As depicted in FIG. 7A, the first segment 44 is connected to the third segment 48 by the first crossover portion 52, while the second segment 46 may be connected to the fourth segment 50 by the second crossover portion 54. Both the first 52 and second 54 crossover portions cross the longitudinal axis. In addition, as shown, the second crossover portion 54 connects the first segment 44 and the fourth segment 50. It should be understood that, in an alternate embodiment, a third crossover portion may connect the first segment 44 and the fourth segment 50.

Turning to FIG. 6A, like the second rail 22, the first rail 20 may be comprised of segments 57 and 59. The fifth segment 57 may include terminals 24 and 26, while the sixth segment 59 may include terminals 28 and 30. Each segment 57, 59 thus includes at least one terminal from the first set (the fifth segment 57 includes terminal 24 and the sixth segment 59 includes terminal 28) and at least one terminal from the second set (the fifth segment 57 includes terminal 26 and the sixth segment 59 includes terminal 30). Looking at FIG. 7A, the second rail may roughly form two different channels. The first channel is formed by the combination of the first segment 44 the first crossover portion 52, and the third segment 48, while the second channel is formed by the second segment 46, the second crossover portion 54, and the fourth segment 50. As shown in FIG. 5, the fifth segment 57 of the first rail 20 may be disposed within the first channel 44, 48, 52 and the sixth segment 59 of the first rail 20 may disposed within the second channel 46, 50, 54.

As shown in FIG. 3, the housing 10 may comprise a cover 60 and a base 62 being connected together by a post 64. The post 64 may be formed by two opposing plastic clips 66, 68 that each grasp a rim of an aperture 70 defined in the center of cover 60. To accommodate the post 64, the fifth segment 57 and the sixth segment 59 may be connected by a first intermediate portion 72, which deviates from the longitudinal axis L. Similarly, the combination of the portion of the first segment that deviates outward from the longitudinal axis L and second crossover portion 54 may define a second intermediate portion. The first intermediate portion 72 and the second intermediate portion are thus disposed in an encircling relation with the post 64.

Base 62 may further feature a narrow tab 82 configured to engage with a slot 84 in cover 60 against base 62. Base 62 may additionally include clips 86 configured to engage with corresponding depressions in cover 60.

The segments of the first rail and second rail may be formed as flat pieces of a conductive material such as brass, phosphor bronze, beryllium copper, a high copper alloy, or some other conductor. The crossover portions, may similarly be formed of flat pieces of a conductive material, arranged perpendicular to the segments to which they connect. (In an alternate embodiment, the first crossover portion 52 and the second crossover portion 54 may be implemented as wires that extend between the respective segments of the second rail 22.) The first rail 20 and second rail 22 may thus each be formed as a rigid unit. In an embodiment, the first rail 20 and the second rail 22 are each integrally formed. For example, each of first rail 20 and second rail 22 may be separately stamped out of sheet metal and bent into the shape depicted in the various figures. Alternately, first rail 20 and second rail 22 may be constructed out of multiple connected pieces. Although the entirety of the first rail 20 and the second rail 22 are described as conductive, in an alternate embodiment, they may be formed of an insulative material, such as plastic, but include traces that conduct current along the respective bodies 40, 42, to the various terminals of the first rail 20 and the second rail 22.

The multiboard power connector 1 may be configured as a push-in wire connector, including apertures 74, 76, each configured to receive a wire from a driver situated outside of the housing 10. Furthermore, first rail 20 and second rail 22 may each include a slot 78, 80 to receive and grasp a respective wire. In alternate embodiments, other types of connectors, as are known in the art, may be used to connect the multiboard power connector 1 to the driver. The multiboard connector is thus configured to receive power from a driver, and to charge the first rail 20 and second rail 22 with opposing charges.

The first rail 20 and second rail 22 may be suspended within the interior space, allowing them to maintain insulation from one another by an air gap. In an alternate embodiment, a layer of insulation may be placed between the first rail 20 and the second rail 22.

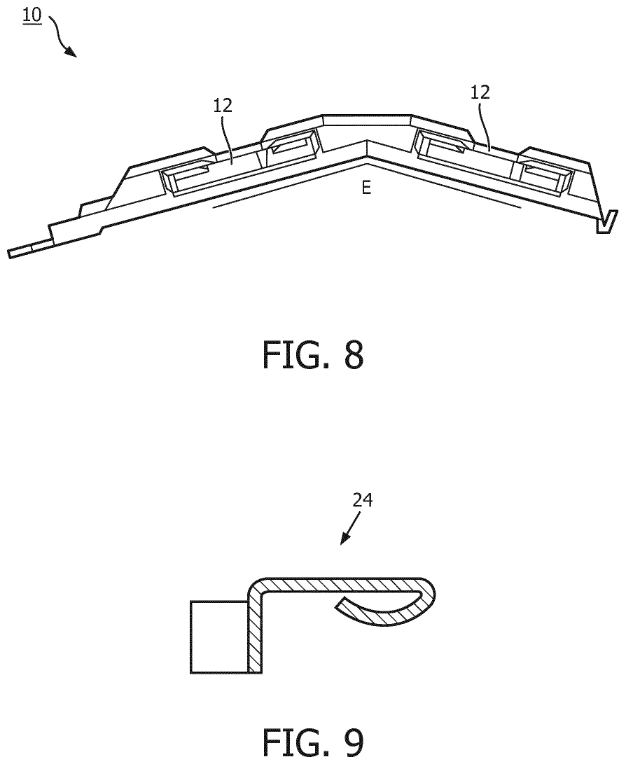

Referring to FIG. 8, the multiboard power connector may also be gabled (i.e., be v-shaped), to accommodate the curvature of the luminaire in which the multiboard power connector resides. The gabled shape may, for example, be implemented by introducing a 150° degree curvature (denoted by angle E in FIG. 8) in the housing 10 and the first rail 20 and second rail 22, respectively, although other curvatures may be employed as required by the lighting fixture. The curvature may be defined about an axis that runs perpendicular to the longitudinal axis L of the first rail 20 and/or of the housing 10.

As shown in FIG. 9, depicting a side-view of terminal 24, each terminal may be a leaf spring terminal having a turned-over edge that exhibits pressure on the respective contact point 16, 18 of circuit board 14, in order to maintain consistent electrical contact when the circuit board 14 is received at the insertion point 12.

Furthermore, although the above-described examples relate to a multiboard power connector with four insertion points, it should be understood that the structure could be expanded to include any number of insertion points, as required. In addition, multiple multiboard connectors 10 may be daisy-changed together by running wires from one multiboard connector 1 to another.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of” or, when used in the claims, “consisting of” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of” “only one of,” or “exactly one of.”

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified.

It should also be understood that, unless clearly indicated to the contrary, in any methods claimed herein that include more than one step or act, the order of the steps or acts of the method is not necessarily limited to the order in which the steps or acts of the method are recited.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively.

While several inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

1. A multiboard power connector, comprising:
a first rail comprising a first body and defining a longitudinal axis, the first rail including a first plurality of terminals, a first set of the first plurality of terminals extending outward from a first side of the first body in a first direction and a second set of the first plurality of terminals extending outward from a second side of the first body in a second direction, the first direction and second direction being opposed, wherein the first rail is conductive; and
a second rail comprising a second body and including a second plurality of terminals, wherein a first set of the second plurality of terminals extend outwardly from a first portion of the second body in the first direction, the first portion being disposed adjacent to the first side of the first body, wherein a second set of the second plurality of terminals extend outwardly from a second portion, of the second body in the second direction, the second portion being disposed adjacent to the second side of the first body, the second rail further comprising a crossover portion connecting the first portion and the second portion and crossing the longitudinal axis,
wherein the first set of the first plurality of terminals and the first set of the second plurality of terminals alternate along a first axis, the first axis being substantially parallel to the longitudinal axis;
wherein the second set of the first plurality of terminals and the second set of the second plurality of terminals alternate along a second axis, the second axis being substantially parallel to the longitudinal axis.

2. The multiboard power connector of claim 1, wherein the first portion comprises a first segment and a second segment, the first segment and second segment being separated by a first gap, wherein at least one terminal of the first set of the first plurality of terminals extends through the first gap.

3. The multiboard power connector of claim 2, wherein the second portion comprises a third segment and a fourth segment being separated by a second gap, wherein at least one terminal of the second set of the first plurality of terminals extends through the second gap.

4. The multiboard power connector of claim 3, wherein a first crossover portion connects the first segment and the third segment, the first crossover portion crossing the longitudinal axis, wherein a second crossover portion connects the second segment and the fourth segment, the second crossover portion crossing the longitudinal axis.

5. The multiboard power connector of claim 4, wherein the first rail comprises a fifth segment and a sixth segment, wherein the fifth segment is disposed in a first channel defined by the first segment, the first crossover portion, and the third segment, wherein the sixth segment is disposed in a second channel defined by the second segment, the second crossover portion, and the fourth segment.

6. The multiboard power connector of claim 5, further comprising a housing defining an interior space, the first rail and the second rail being disposed within the interior space, wherein the housing defines a plurality of insertion points, each insertion point of the plurality of insertion points being dimensioned to receive a corresponding circuit board having a set of contacts comprising a first contact and a second contact.

7. The multiboard power connector of claim 6, wherein the plurality of insertion points comprises a first set of insertion points, each insertion point of the first set of insertion points being positioned such that the first contact of the corresponding circuit board, received into one of the insertion points of the first set of insertion points engages with one terminal of the first set of the first plurality of terminals and the second contact of the corresponding circuit board engages with one terminal of the first set of the second plurality of terminals.

8. The multiboard power connector of claim 7, wherein the plurality of insertion points comprises a second set of insertion point, each insertion points of the second set of insertion points being positioned such that the first contact of the corresponding circuit board, received into one of the insertion points of the second set of insertion points, engages with one terminal of the second set of the first plurality of terminals and the second contact of the corresponding circuit board engages with one terminal of the second set of the second plurality of terminals.

9. The multiboard power connector of claim 8, wherein the housing defines a cover and a base, the cover being connected to the base by a post, wherein the fifth segment and the sixth segment are connected together by a first intermediate portion, the first intermediate portion deviating from the longitudinal axis, wherein the second segment and the third segment are connected together by a second intermediate portion, wherein the first intermediate portion and the second intermediate portion together are in an encircling relation with the post.

10. The multiboard power connector of claim 1, wherein the housing is gabled about a vertex, the vertex being perpendicular to the longitudinal axis.

11. The multiboard power connector of claim 1, wherein the first rail is gabled about a first vertex and the second rail is gabled about a second vertex, the first vertex and the second vertex each being perpendicular to the longitudinal axis.

12. The multiboard power connector of claim 3, further comprising:
a housing defining an interior space, the first rail and the second rail being disposed within the interior space, wherein the housing defines a plurality of insertion points, each insertion point of the plurality of insertion points being dimensioned to receive a corresponding circuit board having a set of contacts comprising a first contact and a second contact,
wherein the first set of the first plurality of terminals and the first set of the second plurality of terminals alternate along a first axis, the first axis being substantially parallel to the longitudinal axis,
wherein the second set of the first plurality of terminals and the second set of the second plurality of terminals alternate along a second axis, the second axis being substantially parallel to the longitudinal axis.

13. The multiboard power connector of claim 12, wherein a first crossover portion connects the first segment and the third segment, the first crossover portion crossing the longitudinal axis, wherein a second crossover portion connects the second segment and the fourth segment, the second crossover portion crossing the longitudinal axis, wherein the first rail comprises a fifth segment and a sixth segment, wherein the fifth segment is disposed in a first channel defined by the first segment, the first crossover portion, and the third segment, wherein the sixth segment is disposed in a second channel defined by the second segment, the second crossover portion, and the fourth segment.

14. The multiboard power connector of claim 12, wherein the plurality of insertion points comprises a first set of insertion points, each insertion point of the first set of insertion points being positioned such that the first contact of the corresponding circuit board, received into one of the insertion points of the first set of insertion points, engages with one terminal of the first set of the first plurality of terminals and the second contact of the corresponding circuit board engages with one terminal of the first set of the second plurality of terminals.

15. The multiboard power connector of claim 14, wherein the plurality of insertion points comprises a second set of insertion points, each insertion point of the second set of insertion points being positioned such that the first contact of the corresponding circuit board, received into one of the insertion points of the second set of insertion points, engages with one terminal of the second set of the first plurality of terminals and the second contact of the corresponding circuit board engages with one terminal of the second set of the second plurality of terminals.
